(19) United States
(12) Patent Application Publication
(10) Pub. No.: US 2008/0271956 A1
(43) Pub. Date: Nov. 6, 2008

(54) Elevator Door Position Detection

(76) Inventors: Michael P. Flynn, Avon, CT (US); Pei-Yuan Peng, Manchester, CT (US)

Correspondence Address: CARLSON GASKEY & OLDS, 400 W MAPLE STE 350, BIRMINGHAM, MI, 48009, US

(21) Appl. No.: 11/570,886

(22) PCT Filed: Jun. 22, 2004
(86) PCT No.: PCT/US04/19930

§ 371 Date: Dec. 19, 2006

(51) Int. Cl. B66B 13/14

(52) U.S. Cl. 187/316

(57) ABSTRACT

An elevator system (20) includes elevator car doors (30) that are moved by a door mover (34) between fully open and fully closed positions. An encoder (38, 38′) provides an absolute indication of a current door position. The encoder (38, 38′) also provides a fully closed door position indication that can be used by a machine controller (40) for controlling when an elevator car (22) is allowed to move within a hoistway. Using an encoder that provides an absolute door position indication allows for eliminating a separate gate switch that otherwise has been used for providing a fully closed door position indication.

### FIELD OF THE INVENTION

This invention generally relates to elevator systems. More particularly, this invention relates to a door position detector arrangement for use in elevator systems.

### DESCRIPTION OF THE RELATED ART

Elevator systems typically include a car that moves between different levels within a hoistway, for example. Depending on the size of the building, for example, the elevator system may be a hydraulic arrangement or may include a car and counterweight suspended by roping. Regardless of the type of powering arrangement, various controls are required to ensure the safety of passengers and those in the vicinity of the hoistway.

One measure that traditionally has been taken is to require that the elevator car doors be fully closed before the car is able to move through the hoistway. While some movement to accommodate releveling during loading or unloading is permitted while the doors are open, in most instances, the elevator machine that is responsible for moving the car is not permitted to cause movement of the car unless the elevator doors are fully closed. The traditional arrangement for detecting whether the elevator doors are closed includes a gate switch. There are a variety of gate switch configurations. One example includes a contact switch where a pin (typically associated with one door) is received in a corresponding hole (typically associated with another door). If the switch does not provide an indication that the doors are fully closed, the car is not allowed to move through the hoistway.

The mechanical arrangement of many gate switches introduces the possibility for maintenance problems associated with the gate switch. This results in call backs and added maintenance expense for some elevator system configurations.

Typical elevator door systems also include motor control components for operating a motor of a door mover. In some examples, control switches are associated with the door mover to provide indications of open and closed positions to control acceleration or deceleration of the motor, for example. Other example arrangements include incremental encoders that provide an indication of a distance moved by an elevator door.

A limitation on the control switches or incremental encoders is that they do not provide an absolute position indication. The resolution of such devices is not considered sufficient enough to provide a reliable indication of a fully closed door. Therefore, codes have required an additional gate switch to provide the fully closed door position indication.

There is a need for an improved arrangement. It would be useful to be able to eliminate the gate switch to eliminate additional expense of an elevator door arrangement and to reduce the number of call backs associated with gate switch malfunction. At the same time, there still is a need for accurately providing a fully closed door position indication to allow the elevator machine to move the car throughout a hoistway as desired. This invention addresses those needs while avoiding the shortcomings and drawbacks of previous arrangements.

### SUMMARY OF THE INVENTION

An example disclosed assembly for controlling selected elevator system components includes an encoder that provides an absolute indication of a current position of an elevator car door. In one example, the encoder detects a position of at least a portion of a motor that causes selective movement of the door. In one example, the encoder comprises an absolute encoder.

In another example, the encoder detects the position of at least one feature of the car door for providing the position indication. In one example, the encoder comprises a linear encoder.

In one example, an elevator car movement controller utilizes the encoder fully closed door position indication for controlling movement of an elevator car.

The various features and advantages of this invention, which include eliminating the gate switch traditionally required for providing a fully closed door indication, will become apparent to those skilled in the art from the following detailed description of currently preferred embodiments. The drawings that accompany the detailed description can be briefly described as follows.

### BRIEF DESCRIPTION OF THE DRAWINGS

FIG. 1 schematically illustrates selected portions of an elevator system incorporating a door position detecting arrangement designed according to an embodiment of this invention.

FIG. 2 schematically illustrates selected portions of another example embodiment.

### DETAILED DESCRIPTION OF THE PREFERRED EMBODIMENTS

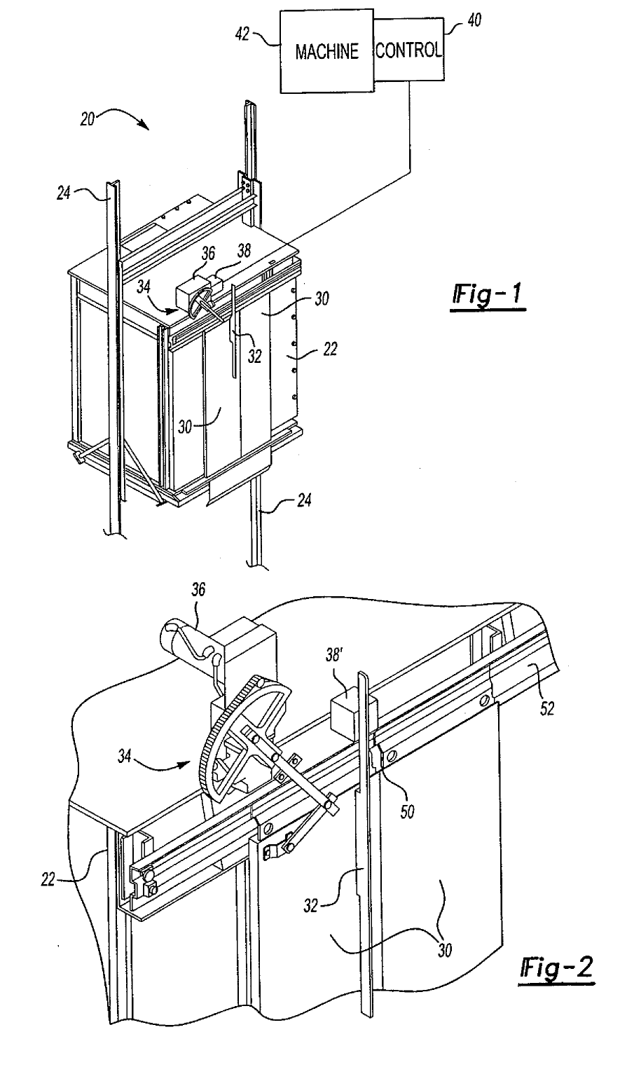

FIG. 1 schematically shows selected portions of an elevator system 20. An elevator car 22 travels along guide rails 24 supported in a hoistway in a conventional manner, for example. Elevator car doors 30 are supported for moving with the car 22 throughout the hoistway and for moving between open and closed positions as known. The example embodiment includes at least one vane 32 supported on the car doors 30 for interlocking the car doors with hoistway doors when the elevator car is appropriately positioned at a landing, for example.

The car doors 30 move responsive to a door mover 34 that includes a motor 36. In one example, the motor 36 comprises a known electrical motor. The door mover 34 operates in a generally known manner to move the doors 30 between open and closed positions.

In the example of FIG. 1, an encoder 38 is associated with the motor 36 for determining a position of at least one portion of the motor 36. In one example, the encoder 38 is associated with a rotating shaft of the motor 36 such that the encoder 38 provides an absolute indication of the position of the car doors 30.

In one example, selecting the known fully open or known fully closed position as a reference point for the encoder 38 allows the encoder to make an absolute determination of a current position of the car doors 30 at any time based upon the amount of movement of the associated portion of the motor 36. Given that the motor parameters and the dimensions associated with door movement are known (or can be determined), the encoder 38 output provides an absolute indication of door position based upon the relationships between motor movement and door movement.

In the example of FIG. 1, the encoder 38 comprises an absolute encoder. A variety of absolute encoders are known and those skilled in the art who have the benefit of this description will be able to select from among-known absolute encoders to meet the needs of their particular situation. In one example, the absolute encoder provides a door position indication with an accuracy of approximately one millimeter. In one example, an accuracy tolerance within the range from about 0.5 millimeters to about 5 millimeters is acceptable.

By selecting an appropriate level of accuracy for the encoder 38, it becomes possible to eliminate a separate gate switch for providing a fully closed door position indication. In the example of FIG. 1, the encoder 38 provides a signal to a controller 40 that is responsible for controlling the elevator machine 42, which causes the car 22 to move along the guide rails 24. In this example, the controller 40 utilizes the encoder door position indication for purposes of controlling whether the car 22 can move, which is permitted only when the doors are in a fully closed position, for example. In this example, no separate gate switch is required. This example provides significant cost savings in materials, labor and maintenance compared to arrangements that require a separate gate switch.

FIG. 2 schematically illustrates another example arrangement where an encoder 38′ detects the position of the doors 30 directly rather than detecting a position of a portion of the motor 36 (as was the case in the embodiment of FIG. 1). In this example, a hanger portion 50 of the doors 30 rides along a track 52 as the doors move between the open and closed positions. The encoder 38′ is positioned to detect at least one feature of the doors 30 in the fully closed position in this example. The encoder 38′ preferably is arranged relative to the doors 30 to provide a current door position indication at all positions along the entire travel of the doors between the fully open and fully closed positions.

In one example, the encoder 38′ comprises a known linear encoder. The door position indication from the encoder 38′ can be used for controlling the motor 36 such as accelerating or decelerating the motor near the ends of door travel. Additionally, the door position indication from the encoder 38′ provides a signal to a controller 40 that operates the machine 42 for moving the elevator car. Like the embodiment of FIG. 1, the example of FIG. 2 allows for having an encoder provide an absolute indication of a fully closed door position that is useful for controlling car movement in addition to being useful for controlling door mover operation.

The disclosed example embodiments demonstrate how an encoder that provides an absolute door position indication allows for eliminating a separate gate switch, which provides an improved, more economical arrangement.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1-20. (canceled)

21. An assembly for controlling selected elevator system components, comprising:
an encoder that provides an absolute indication of a current position of an elevator car door; and
an elevator car movement controller that controls movement of an associated elevator car responsive to the absolute indication from the encoder.

22. The assembly of claim 21, including a motor that causes selective movement of the door and the encoder detects a position of at least a portion of the motor for providing the indication.

23. The assembly of claim 22, wherein the encoder comprises an absolute encoder.

24. The assembly of claim 21, wherein the encoder provides a fully closed door position indication.

25. The assembly of claim 24, wherein the elevator car movement controller uses the encoder fully closed door position indication for controlling movement of the associated elevator car.

26. The assembly of claim 25, wherein the car movement controller prevents movement of the elevator car if the encoder does not provide the fully closed door position indication.

27. The assembly of claim 24, including at least one car door that is moveable between a fully open position and the fully closed position and wherein the encoder cooperates with at least one feature of the door for providing the indication.

28. The assembly of claim 27, wherein the encoder comprises a linear encoder.

29. The assembly of claim 21, wherein the absolute indication of the current position has an accuracy within a range from about 0.1 mm to about 5 mm.

30. The assembly of claim 21, wherein the encoder uses a selected door position as a reference position and wherein the current position indication is determined relative to the reference position.

31. The assembly of claim 30, wherein the reference position is one of a fully closed door position or a fully open door position.

32. A method of controlling an elevator door assembly, comprising:
using an encoder to provide an absolute current door position indication including at least a fully closed door position indication.

33. The method of claim 32, including controlling movement of an associated elevator car responsive to the fully closed door position indication.

34. The method of claim 32, including detecting a position of at least a portion of a motor and using the detected position for providing the door position indication.

35. The method of claim 34, including using an absolute encoder.

36. The method of claim 32, including selecting a reference door position and determining the current door position relative to the reference door position.

37. The method of claim 36, including selecting at least one of a fully open or the fully closed door position as the reference position.

38. The method of claim 32, including providing the current door position indication with an accuracy in a range from about 0.1 mm to about 5.0 mm.

39. The method of claim 32, including detecting a position of at least one feature of a door and using the detected position for providing the door position indication.

40. The method of claim 39, including using a linear encoder.
